(19) United States
(12) Patent Application Publication
(10) Pub. No.: US 2004/0100490 A1
(43) Pub. Date: May 27, 2004

(54) Skin button enhancements for remote control

(75) Inventors: Stephen B. Boston, Cedar Park, TX (US); Michael A. Paolini, Austin, TX (US)

Correspondence Address: BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY

(21) Appl. No.: 10/302,469

(22) Filed: Nov. 21, 2002

(51) Int. Cl. G09G 5/00

(52) U.S. Cl. 345/744; 345/749

(57) ABSTRACT

Creating a skin for a client device, including creating, in dependence upon button attributes, one or more buttons for the skin, in which the skin includes one or more buttons for the skin and each button comprises graphics associated with a portion of a GUI on the client device, and downloading the one or more buttons for the skin from a source of skins to the client device. Embodiments include downloading only a subset of the buttons for a skin, including incrementally downloading two or more staggered subsets of the buttons for a skin to entice viewers to take one or more predetermined actions. Embodiments include programming triggers for date and time, wherein the triggers go off regardless whether the client device is presently available to receive downloaded buttons.

### FIELD OF THE INVENTION

The field of the invention is data processing, or, more specifically, methods, systems, and products for creating, downloading, and installing skins for remote controls.

Description of Related Art

A skin is downloadable computer software controlling the overall appearance of a GUI on a client device, such as, for example, an MP3 player, a PDA, or a screen on a laptop computer. Skins are used for user interface and appearance enhancement. Skins are available for download from various sources. Skins are created and provided to the sources of skins by enthusiasts and various commercial interests, such as, for example, makers of MP3 players.

‘Buttons’ are elements or components of skins. Skins and buttons are basically software. As software, skins and buttons provide means for altering interface function as well as appearance. In current art, however, such alterations are possible only at the level of the skin. Downloads are downloads of entire skins rather than being controllable button-by-button. GUI space and download bandwidth, however, are sufficiently scarce so that it would be advantageous if such alterations were possible at the button level, within a skin.

### SUMMARY OF THE INVENTION

Exemplary embodiments of the invention include methods for creating a skin for a client device. Exemplary embodiments include creating, in dependence upon button attributes, one or more buttons for the skin, in which the skin includes one or more buttons for the skin and each button comprises graphics associated with a portion of a GUI on the client device. Such embodiments include downloading the one or more buttons for the skin from a source of skins to the client device.

In exemplary embodiments, downloading the buttons for a skin from a source of skins to the client device includes downloading only a subset of the buttons for the skin. In such embodiments, downloading the buttons for a skin includes incrementally downloading two or more staggered subsets of the buttons for a skin to entice viewers to take one or more predetermined actions. Typical embodiments include detecting a button creation trigger event, in which creating buttons includes creating buttons in response to the button creation trigger event. Such embodiments include programming triggers for date and time, in which the triggers go off regardless whether the client device is presently available to receive downloaded buttons.

In exemplary embodiments of the invention, downloading the buttons for a skin includes downloading the buttons from a source of skins to an intermediate appliance, and further downloading the buttons from the intermediate appliance to the client device. In such embodiments, at least a portion of the GUI on the client device is interactive, and the downloaded buttons affect interactive functions of the client device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram depicting an architectural arrangement of information handling systems in which exemplary embodiments of the present invention may be implemented.

FIG. 2 is a diagram depicting a more detailed architectural arrangement of an intermediate appliance according to the present invention, depicted for example as a PVR, and a client device according to the present invention, depicted for example as a remote control for a PVR.

FIG. 3 is a line drawing depicting in more detail a client device according to the present invention, in FIG. 3, depicted for example as a remote control for a PVR.

FIG. 4 is a block diagram of an exemplary intermediate appliance according to the present invention, in the example of FIG. 4, a PVR.

FIG. 5 is a pie chart illustrating an example of storage space allocation on a PVR, an intermediate appliance according to the present invention.

FIG. 6 depicts data structures as related records useful in exemplary embodiments according to the present invention, particularly with respect to the PVR as an exemplary intermediate appliance.

FIG. 7 depict data structures as related records useful in exemplary embodiments according to the present invention, particularly with respect to skins and buttons.

FIG. 8 sets forth a data flow diagram depicting a method for creating a skin, including creating buttons for a skin.

FIG. 8a is an example of an SVG graphic.

FIG. 9 sets forth a data flow diagram depicting a further method for creating a skin, including detecting button creation trigger events.

FIG. 10 sets forth a flow chart depicting a further aspect of the invention regarding triggers for date and time.

FIG. 11 sets forth a data flow diagram depicting a further method for creating a skin, including partial downloads of subsets of buttons for a skin and indirect downloads through an intermediate appliance.

FIG. 12 sets forth a flow chart depicting a further aspect of the invention regarding multipart, incremental downloads of skins.

### DETAILED DESCRIPTION OF EXEMPLARY EMBODIMENTS

### Introduction

The present invention is described to a large extent in this specification in terms of methods for creating, downloading, and installing skins for remote controls. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field” and “data element,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

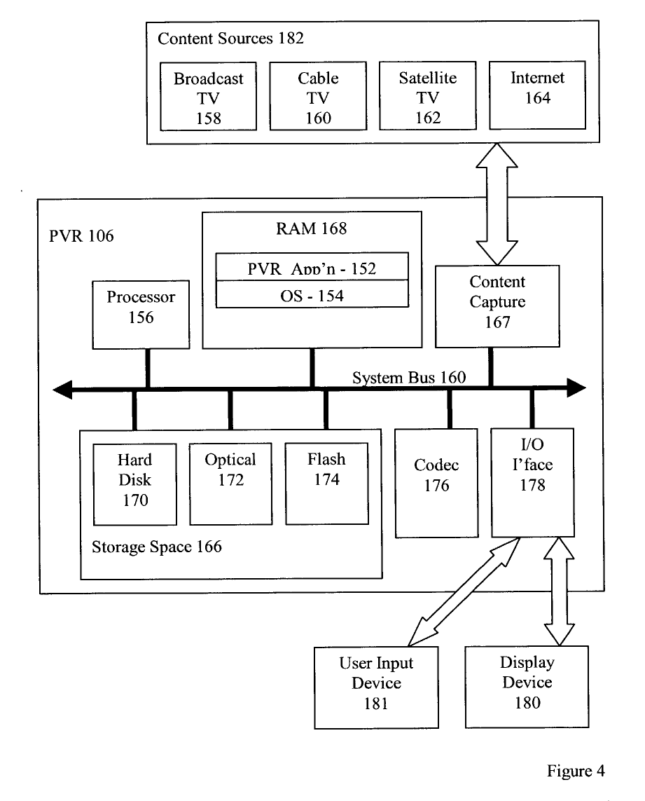

“Codec” is an industry-standard term referring to “encoder/decoder,” or perhaps more legibly, “coder/decoder”. Codecs are means and methods for encoding and decoding video with audio. Codecs are implemented in hardware or in software. The codec illustrated at reference 176 in FIG. 4, shown in a system or apparatus diagram, is implicitly a hardware codec. Software-only codecs are freely available for downloading from various sources on the Internet. There are many codecs, including, for example, Cinepak, Motion JPEG, and, of course, MPEG. Codec functions include compression and decompression. When a show is encoded, it is converted to a compressed format suitable for storage or transmission; when it is decoded it is converted to a non-compressed (raw) format suitable for presentation.

“Coupled for data communications” means any form of data communications, wireless, 802.11b, Bluetooth, infrared, radio, internet protocols, HTTP protocols, email protocols, networked, direct connections, dedicated phone lines, dial-ups, serial connections with RS-232 (EIA232) or Universal Serial Buses, hard-wired parallel port connections, network connections according to the Power Line Protocol, and other forms of connection for data communications as will occur to those of skill in the art. Couplings for data communications include networked couplings for data communications. Examples of networks useful with various embodiments of the invention include cable networks, intranets, extranets, internets, local area networks, wide area networks, and other network arrangements as will occur to those of skill in the art. The use of any networked coupling among television channels, cable channels, video providers, telecommunications sources, and the like, is well within the scope of the present invention.

“802.11” refers to a family of specifications developed by the IEEE for wireless LAN technology. 802.11 specifies an over-the-air interface between a wireless client and a base station or between two wireless clients. Various embodiments of the present invention implement RF couplings for data communications between client devices and sources of skins or intermediate appliances by use of wireless data communications according to 802.11.

“Bluetooth” refers to an industrial specification for a short-range radio technology for RF couplings among client devices and between client devices and resources on a LAN or other network. An administrative body called the Bluetooth Special Interest Group tests and qualifies devices as Bluetooth compliant. The Bluetooth specification consists of a ‘Foundation Core,’ which provides design specifications, and a ‘Foundation Profile,’ which provides interoperability guidelines. Various embodiments of the present invention implement RF couplings for data communications between client devices and sources of skins or intermediate appliances by use of wireless data communications according to the Bluetooth specification.

“HAVi” stands for ‘Home Audio Video interoperability,’ the name of a vendor-neutral audio-video standard particularly for home entertainment environments. HAVi allows different home entertainment and communication devices (such as VCRs, televisions, stereos, security systems, and video monitors) to be networked together and controlled from one primary device, such as a PC or television. Using IEEE 1394, the ‘Firewire’ specification, as the interconnection medium, HAVi allows products from different vendors to comply with one another based on defined connection and communication protocols and APIs. Services provided by HAVi's distributed application system include an addressing scheme and message transfer, lookup for discovering resources, posting and receiving local or remote events, and streaming and controlling isochronous data streams. Various embodiments of the present invention implement couplings for data communications between client devices and sources of skins or intermediate appliances by use of data communications according to the HAVi standard.

“OSGI” refers to the Open Services Gateway Initiative, an industry organization developing specifications for service gateways, including specifications for delivery of service bundles, software middleware providing compliant data communications and services through service gateways. The Open Services Gateway specification is a java based application layer framework that gives service providers, network operator device makers, and appliance manufacturer's vendor neutral application and device layer APIs and functions. In some embodiments of the present invention, buttons for skins are downloaded to client devices through OSGI compliant gateways as OSGI compliant service bundles. In some embodiments of the present invention, intermediate appliances comprise OSGI compliant gateways.

Various embodiments of the present invention implement data communications between client devices and sources of skins or intermediate appliances by use of data communications according to the HAVi standard.

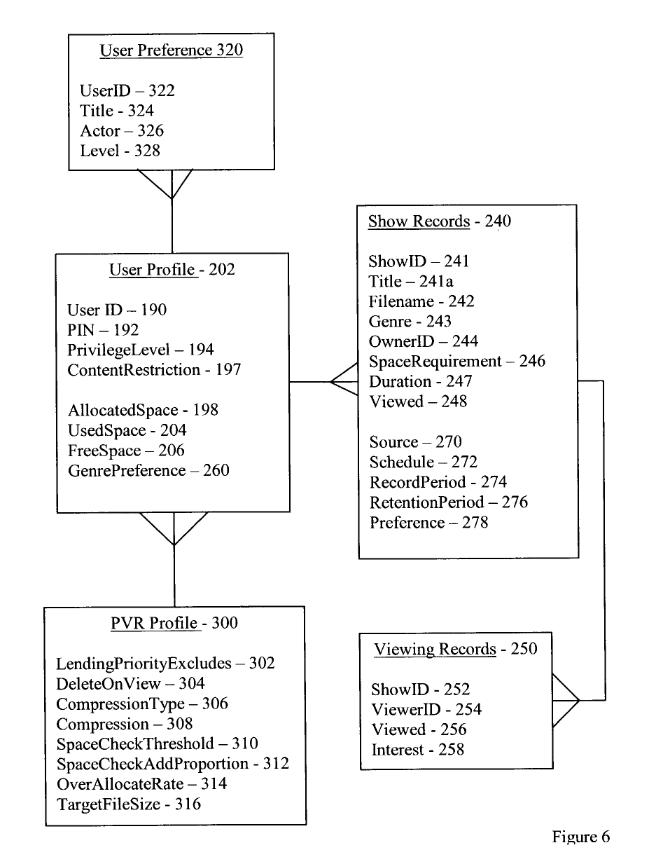

“ID” abbreviates “identification,” meaning ‘identification code’ or identification field. It is a style of reference in this disclosure to refer to identification codes for an entity by an entity name concatenated with ‘ID.’ So that, for example, user identification codes are referred to as “user IDs.” Show identification fields are referred to as ‘showIDs.’ And so on. Conversely according to this convention, a field named “UserID” is used to store a user identification code, a user ID. That is, for example, the UserID field 190 in the example user profile 202 in FIG. 6 contains a user ID of a registered user on a PVR.

“ISP” means “Internet Service Provider,” a company that provides access to the Internet. For a monthly fee, an ISP provides a user identification code (often called a ‘username’), a password, and an access phone number or, for wide band services, an internet protocol address, through which to access the Internet. Equipped with proper couplings for data communications, such as a modem or cable modem, users and companies can then log on to the Internet, browse the World Wide Web, and access other Internet related services such as USENET and e-mail. In providing services to companies, ISPs also provide direct connections from companies' networks to the Internet.

“JPEG” stands for Joint Photographic Experts Group, the original name of the committee that developed the standard. JPEG is a data compression standard for graphic images. JPEG can reduce files sizes to about 5% of their uncompressed size, although some detail is lost in the compression. “Motion JPEG” or “MJPEG” extends the JPEG standard by supporting video. In Motion JPEG, each video frame is stored using the JPEG format. In this regard, note that the 5% compression estimate for JPEG is the effect of the compression algorithm alone, without regard to frame rate, resolution, and so on.

“MPEG” stands for ‘Moving Picture Expert Group,’ a working group under “ISO,” the International Organization for Standardization and “IEC,” the International Electrotechnical Commission. What is commonly referred to as “MPEG video” actually includes three standards, MPEG-1, MPEG-2, and MPEG-4. MPEG-1 and MPEG-2 are similar. They both work on motion compensated block-based transform coding techniques. MPEG-4 differs in its use of software image construct descriptors for target bit-rates in the very low range, less than 64 Kb/sec.

“MP3” is a standard for audio encoding and compression defined in MPEG-2.

“PDA” abbreviates ‘personal digital assistant.’

“Show” means any recordable or distributable electronic or digital content including television broadcasts, movies, CD contents, DVD recordings, cable transmission, satellite transmissions, commercial video clips, audio, multi-media programming, and the like. Shows include any image or series of images delivered to users through any mechanism or means, including associated audio or other multi-media content.

“Video” as the term is used in this disclosure, and according to context, generally includes audio and other media.

“World Wide Web,” or more simply “the web,” refers to a system of internet protocol (“IP”) servers that support specially formatted documents, documents formatted in markup languages such as HTML (HyperText Markup Language), XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP (HyperText Transfer Protocol) or WAP (Wireless Access Protocol), in support of URIs and documents in markup languages, regardless of whether such servers or groups of servers are coupled to the World Wide Web as such.

### Skin Buttons for Client Devices

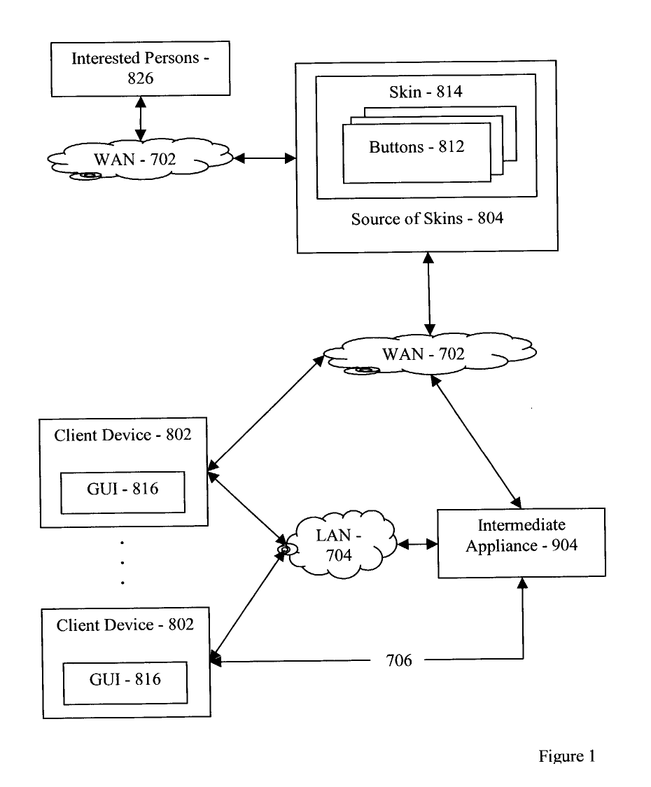

FIG. 1 depicts a data processing architecture useful with various embodiments of the present invention. The architecture of FIG. 1 includes interested persons 826 who upload to a source of skins 812 graphic images and optionally button parameters for inclusion in buttons 812 comprising skins 814.

‘Buttons’ 812 are elements or components of skins. A skin 814 is downloadable computer software controlling the overall appearance of a GUI 816 on a client device 802. The fact that skins are downloadable means that a GUI on a client device can change dynamically as a series of skins is downloaded and applied to affect the appearance of the GUI. A skin 812 comprises buttons 812 for the skin, and each button comprises downloadable software controlling the appearance of a portion of a GUI 816 on a client device 802.

Skins and buttons for skins are downloaded from sources of skins 804 to client devices 802. Downloads can be effected across wide area networks or ‘WANs’ 702 such as, for example, the Internet, directly from a source of skins through a network to a client device or indirectly through an intermediate appliance 904. Client devices can be coupled for data communications through a local area network 704 (“LAN”) to an intermediate appliance 904.

Client devices 802 are any aggregation of automated computing machinery supporting a GUI and capable of coupling for data communications, directly or indirectly, to a source of skins. Examples of client devices include PDAs, personal computers, laptop computers, remote controls for home entertainment equipment as well as office equipment, and others as will occur to those of skill in the art. An example of a client device used often as an example in this disclosure is a remote control for a PVR.

Intermediate appliances 904 include any aggregation of automated computing machinery capable of supporting couplings for data communications between a client device and a source of skins. Examples of intermediate appliances include PVRs, personal computers, file servers on home or office LANs, OSGi-compliant gateways, and others as will occur to those of skill in the art.

LANs 704 include any technology capable of supporting locally networked couplings for data communications. Examples of LANs include Ethernets, internet protocol networks, Bluetooth wireless networks, IEEE 802.11 wireless networks, HAVi networks, and others as will occur to those of skill in the art.

Sources of skins 804 are aggregations of computer hardware, software, servers, application programs, and the like, designed and implemented to provide skins, and elements or components of skins, such as button, for download to client devices such as remote controls for televisions, stereos, and PVRs. A source of skins 804 can be any source of program content or data communications including, for example, cable television channels, telecommunications services, Internet service providers, or web sites. Contemporary examples of sources of skins include Nullsoft's website at http://www.winamp.com and Lycos's website at http://sonique.lycos.com.

Interested persons 826 include any person or entity authorized to install skins, skin elements or components, buttons, or button attributes, onto a source of skins for eventual download to a client device. Examples of interested persons include users of client devices who upload their favorite skins to a source of skins to make their favorite skins available for subsequent download to client devices; advertisers who rent button space on GUIs on client devices; user groups; manufacturers of PVRs, PDAs, televisions, stereos, and other appliances; producers or promoters of shows or program content who want skins and buttons that advertise, support, or enhance a show or other program content; a cable televisions channel wishing to broadcast skins or buttons advertising, supporting, or enhancing the viewing of shows or program content provided through the channel; an ISP wishing to advertise, support or enhance shows or downloadable program content available from the ISP; and other interested persons as will occur to those of skill in the art.

In typical embodiments of the present invention, sources of skins 804 support interfaces through which persons interested in buttons for skins can upload button elements across, for example, a wide area network 702 such as, for example, an internet. Interfaces supported by sources of skins can also present predefined skins and skin components such as buttons for interested persons to select among, thus saving the interested persons the work of defining and uploading their own skins and buttons. Interfaces supported by sources of skins can also make available editing functions so that interested persons can create their own skins and buttons on-line or edit predefined skins and buttons on-line. Interfaces supported by sources of skins are typically implemented as web sites accessible through browsers.

In terms of the exemplary architecture of the FIG. 1, therefore, it is seen that in typical embodiments of the present invention, interested persons 826 represent a supply-side starting point for supply of skins 814 and buttons 812. Sources of skins 804, on the other hand, function as repositories from which skins and buttons are downloaded by user-side client devices 802 for actual utilization. ‘Users’ as such, and others persons also, sometimes act as both users of client devices, and therefore users of skins and buttons, as well as interested persons who supply skins and buttons to sources of skins.

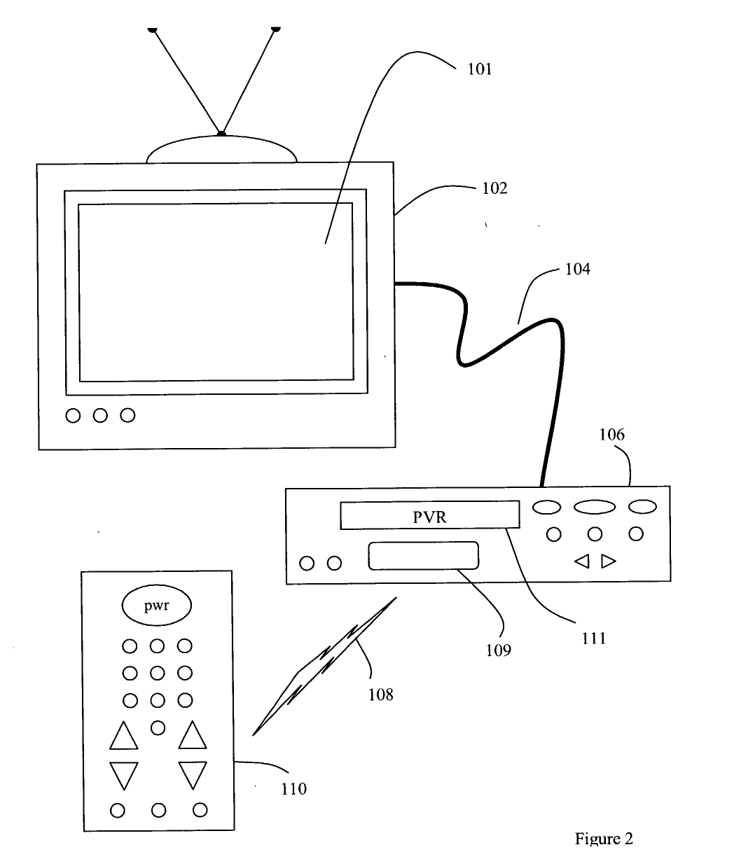

FIG. 2 is a pictorial representation of a typical context of installation of one kind of intermediate appliance according to the present invention, that is, a PVR. The PVR 106 of FIG. 2 is a set top box, similar in size and shape to a cable television box or a video cassette recorder (“VCR”). PVR 106 is connected to a television 102 for display on a display screen 101 of television shows, movies, or other content, as well as display of operational information regarding the PVR itself and its stored or recorded content. By “stored content” or “recorded content” is meant any information or entertainment content capable of being recorded in an environment comprising automated computing machinery, including, for example, broadcast television shows, cable television shows, motion pictures, personal video clips from video recorders, audio and music pieces, video/audio downloaded from Internet locations, and material sourced from optical storage such as compact discs. In fact, the example PVR 106 shown in FIG. 2 includes a read/write compact disc drive supporting removable media. Again for clarity of reference, “stored content” is often referred to in this disclosure as “shows.”

The PVR 106 is connected to the television 102 by cable 104. The cable connection 104 can be for video and audio through a standard video cable, or for television broadcast frequencies through a standard coaxial cable.

A remote control unit 110 allows users to interact with and control the PVR 106. The remote control unit 110 is an example of a client device (reference 802 on FIG. 1) according to the present invention. Remote control unit 110 emits infrared (“IR”) signals, radio frequency (“RF”) signals, although other kinds of remote control emissions are within the scope of the invention, including for example radio frequency (RF″) signals. The example PVR 106 includes an IR window 109 for receipt of information and instructions from remote control unit 110. Functions provided by use of the remote control unit 110 include the ability to move a cursor on a display and select items shown on a display.

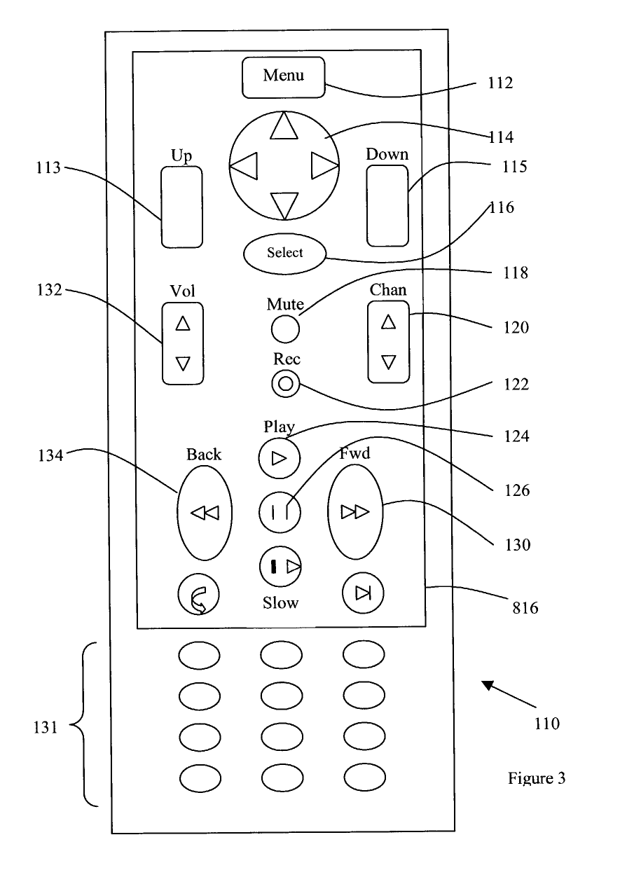

FIG. 3 is a more detailed depiction of a remote control unit 110 useful as a client device in various embodiments of the present invention. Although it is discussed generally in this disclosure in the context of controlling a PVR, the remote control unit of FIG. 3 is readily adapted to control any device to which it can be coupled for usually wireless data communications through for example an infrared coupling or a radio frequency coupling. Such devices include television sets, stereos, lighting systems, VCRs, PVRs, and other as will occur to those of skill in the art.

The remote control unit of FIG. 3 includes a GUI 816 upon which buttons are implemented. The remote control unit is an aggregation of computer hardware and software which can be modeled as a computer in the fashion set forth in FIG. 4.

FIG. 4 is a block diagram of an intermediate appliance, an exemplary PVR. Such a PVR, however, is largely a computer, and so is the remote control unit of FIG. 3, which also has a processor, random access memory, non-volatile memory, an input-output subsystem, and so on. The GUI 816 is considered part of the input-output subsystem of such a remote control unit, and it is divided into portions each of which is controlled by button software, each of which, when considered with its button software, is referred to in this disclosure as a ‘button.’ The remote control unit 110 includes conventional numeric keys 131, physical switches, rather than ‘buttons.’ The principal physical aspect of terms ‘buttons’ in this disclosure is portions of a GUI rather than physical switches.

The GUI 816 on the remote control unit 110 includes a “Menu” button for use in accessing a central set of menus and data entry screens for configuring the PVR, configuring user profiles on the PVR, and scheduling shows. The GUI 816 includes “Up” and “Down” buttons 113 and 115 that allow users to change displays page-by-page rather than by scrolling line-by-line or item-by-item. Navigation buttons 114 support scrolling. The “Select” button 116 is used to select a display item after paging and scrolling have located the item.

The GUI 816 includes buttons associated with television and recorded playback control including a “Volume” control button 132, a “Channel” selector button 120, a “Mute” button 118, and buttons for “Play” 124, a rewind button called “Back” 134, a fast forward button labeled “Fwd” 130, and a pause button 126. The “Record” button 122 is used to instruct a PVR to record a show typically when the show has been selected, for example, through navigation through a series of display screens depicting television broadcast schedules for televisions shows.

In the previous few paragraphs, an embodiment of the present invention is described as a data processing system with automated computing machinery configured as a PVR, a set top box coupled to a television for display and user interaction and controlled by a remote control unit. It is useful to understand that the set top box configuration is not at all the only configuration of a PVR, nor the only configuration of intermediate appliances generally, within the scope of the present invention, and to clarify this point, we ask the reader to consider, for example, PVRs, or indeed any intermediate appliance, implemented as software installed upon general purpose computers, personal computer, laptop computers, handheld computers, and the like. In the case of a PVR embodied upon a personal computer, for example, the PVR is implemented as software installed in computer memory to embody data processing methods of the invention.

Although a PVR implemented as a set top box will include by special design within the set top box all the hardware resources needed to implement the steps of the invention and store content in accordance with the invention, not all computers will possess such hardware. To the extent that any general purpose computer, however, and today many of them do, possesses sufficient resources to download, read from a compact disc, receive cable television, or otherwise access recordable content, and sufficient resources to store such recordable content on hard disk, writable optical drives, or other storage media, then any general purpose computer can be configured as a PVR according to an embodiment of the present invention. Similarly, personal computer, laptop computers, handheld computers, personal digital assistants (PDAs), and the like as will occur to those of skill in the art, can implement a variety of intermediate appliances and a variety of client devices within the scope of the present invention.

Continuing with the example of a PVR: For PVRs embodied in general purpose computers according to the present invention, PVR controls are implemented through the usual user interface as provided in connection with any particular computer terminal, computer screen, computer keyboard, computer mouse, and so on. In this sense, general purpose computers include personal computers, portable computers, minicomputers, mainframes, laptop computers, handheld computers, personal digital assistants, wireless Internet-enabled cell phones, and so on.

FIG. 4 sets forth a block diagram of automated computing machinery comprising an intermediate appliance, a PVR 106, according to an exemplary embodiment of the present invention. The PVR 106 of FIG. 4 includes at least one computer processor 156 as well as random access memory 152 (“RAM”). Stored in RAM 168 is a PVR application program 152 implementing inventive methods of the present invention.

Also stored in RAM 168 is an operating system 154. The PVR of the present example is implemented for personal video recording for multiple users. The multi-user features of the example PVR can be implemented as application software. Such a PVR therefore can use as its operating system 154 a single-user operating system, such as Microsoft's Disk Operating System or “DOS.” Alternatively, at least some of the work of administering user accounts for many users may be downshifted to a multi-user operating system such as Unix, Linux, or Microsoft NT™. As an additional alternative, an operating system can be developed as a special purpose system just for use in such a PVR. In fact, any arrangement of operating systems for client devices and for intermediate appliances as will occur to those of skill in the art is well within the scope of the present invention. This disclosure discusses multiple users as having “user profiles,” so as to distinguish application-level user administration from any operating system's administration of ‘user accounts.’

The PVR 106 of FIG. 4 includes storage space 166 for shows. Storage space 166 can be implemented as hard disk space 170, optical drive space 172, electrically erasable programmable read-only memory space (so-called ‘EEPROM’ or ‘Flash’ memory) 174, RAM drives (not shown), or as any other kind of computer memory capable of receiving and storing recorded content as will occur to those of skill in the art.

The example PVR 106 of FIG. 4 includes a subsystem for content capture 167. This subsystem for content capture 167 is implemented in typical embodiments according to content sources 182 and can include in various embodiments a broadcast television tuner for receipt of broadcast television 158, a cable box for receipt of cable television 160, a satellite receiver for receipt of satellite television 162, and an Internet connection for downloading recordable content from the Internet 164.

The example PVR of FIG. 4 includes a codec 176, which can take the form of a video card plugged into the system bus of a personal computer, or other forms as will occur to those of skill in the art. The codec 176 provides video and audio output from recorded shows in storage space 166 to an input/output interface 178. The codec 176 can also provide changes in video compression or video quality as needed in particular instances. The input/output interface provides video and audio output to a display device 180. In the case of PVRs implemented with connection to televisions, the display device 180 is a television. In the case of PVRs implemented as general purpose computers, the display device is often implemented as a computer screen. The display device 180 is any device, as will occur to those of skill in the art, capable of displaying video and audio content.

The example PVR of FIG. 4 includes an input/output interface 178. The input/output interface 178 in PVRs implemented as general purpose computers is a computer interface including, for example, conventional software drivers and computer hardware for controlling output to display devices 180 such as computer screens, as well as user input from user input devices 181 such as computer keyboards and computer mice. In the case of PVRs as set top boxes, an input/output interface 178 comprises, for example, software drivers and computer hardware for controlling displays on display devices 180 such as television screens and user input from user input devices 181 such as remote control devices (like the example illustrated at reference 110 in FIGS. 2 and 3).

FIG. 6 illustrates several example data structures useful in various embodiments of the present invention. Such data structures are described in this example as part of the PVR application software (reference 152 on FIG. 4) and are usually stored in RAM (168 on FIG. 4) or, for longer-term or non-volatile storage, on a hard disk (170 on FIG. 4), optical drive (172 on FIG. 4), or other non-volatile storage as will occur to those of skill in the art. The example data structures of FIG. 6, for clarity of explanation, are shown related as records in a database, although other data storage arrangements as will occur to those of skill in the art are possible, all such arrangements being well within the scope of the present invention.

FIG. 6 depicts an example user profile 202, useful for registering multiple users on PVRs like the one of the present example. The user profile 202 represents a user registered on the PVR in which the profile is installed and sets forth characteristics and limitations regarding the user and the user's privileges to operate the PVR. More specifically, the user profile 202 includes data elements for storing an user identification or “UserID” 190, a password or personal identification number called a “PIN” 192, a user privilege level 194, and content restrictions 196 on recordable content allowed for the user.

A PIN 192 is assigned to a user at registration time, when a user registers as a user on the PVR, and is unique to a user. In PVRs implemented as set top boxes, it is common to utilize numeric PINs because they are easily entered through numeric keys or buttons on remote control units (reference 131 on FIG. 3). Numeric PINs, of course, are not a requirement of the invention. PVRs or other intermediate appliances implemented upon general purpose computers or any device having a keyboard, for example, would experience no particular benefit from numeric-only PINs or passwords.

The user privilege level 194 provides the capability of distinguishing privileges according to class of user. That is, the user privilege level 194 supports the establishment of classes of users having various levels of privilege. A common example is a class of administrative users or ‘super users’ who are privileged to edit the profiles of other users. In a home setting, therefore, parents would often be super users privileged to set content restrictions on children's profiles. In a business setting, system administrators in the Information Technology Services organization would often be privileged to create and administer profiles for users with normal usage privileges.

The example user profile 202 of FIG. 6 also provides several example data elements for recording characteristics of storage space available for recording shows on behalf of the user represented by the profile. The user profile 202 provides data elements for allocated space 198, used space 204, and free space 206.

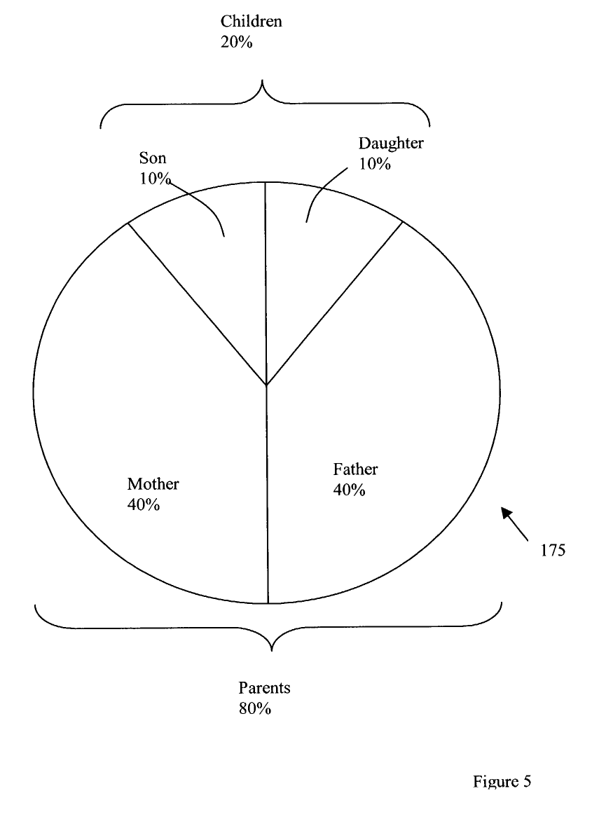

The allocated space field 198 records the amount of storage space presently allocated to the user. It is usual, although not a requirement of the invention, that the allocated space is altered only by super users, so that normal users avoid conflict risked by normal users changing their own storage space allocations. An initial quantity of allocated space is assigned to each user at registration time, when the user's user profile is created. FIG. 5 sets forth a pie chart 175 showing an example of allocation of storage space in a residential setting. In the example allocation of FIG. 5, allocation of 100% of the storage space of a PVR within a family includes allocation of 80% of the storage space for parents (40% for father and 40% for mother) and allocation of 20% of the storage space for children (10% for a son and 10% for a daughter).

As the user records shows in the user's allocated space, when a show is recorded in a user's allocated storage space, some of the storage space, the space upon which the show is recorded, is said to be ‘used.’ Each show has a storage space requirement that uses some of a user's allocated storage. The current total of the used space of all the shows recorded for a user can be stored in the UsedSpace field 204. The free space field 206 is provided for storing the difference between allocated space 198 and used space 204. When a PVR records a show for a user, the PVR increments UsedSpace 204 by the amount of the show's storage requirement and decrements FreeSpace 206 by the same amount.

The example data structures of FIG. 6 include show records 240. A show record 240 is a data structure representing a segment or clip of recorded content scheduled to be recorded through the PVR, such as video and audio, for example, a television show or a motion picture. There are generally two sources of show records 240, user scheduling and preference recording. “User scheduling” is a user's entering through a user interface a title and recording schedule for the show. The user interface will vary from PVR to PVR. The user interface, in PVRs implemented as set top boxes, is typically a remote control unit maneuvering a pointer over a scrolling list of television shows on a television screen. The user interface, in PVRs implemented as personal computers, is typically a keyboard, a mouse, and a computer screen upon which is displayed a mouse pointer used to highlight and select from scrolling lists of television programs or web sites hosting video clips of interest.

“Preference recording” is a PVR's being programmed to select and record shows based upon previous indications of user preference. Previous indications of user preference are implemented, for example, as a genre preference 260 in a user profile 202, causing a PVR so programmed, when a user has sufficient free space to support such recording, reading the user's previously indicated preference for Comedy, Drama, Science Fiction, or Sports, for example, scanning presently available sources, selecting the first show that matches the user's genre preference for which the user has sufficient free space, and recording that show. In accordance with the present invention, the PVR can be programmed to borrow space from another user if the user has insufficient free space to store the show.

Alternatively, to achieve even greater power to express particular preferences, PVRs can support separate user preference records 320 linked to user profile 202 through a userID 322 as a foreign key. Such separate preference records 320 can support any indication of user preference including, for example, preferences for particular actors 326, preferences for particular title 324, and indications of a user's intensity of preference, encoded as preference Level 328. With respect to preference levels 328 in particular, the PVR can be programmed to record a range of preference levels, for example, 1 through 10, in which a preference level of ‘10’ indicates that the user likes a particular show title very much, ‘5’ indicates neutrality, and a ‘1’ indicates dislike. The Boolean field ‘Preference’ 278 on the show record 240 indicates whether a recording is a preference recording. So that a user can know what has been recorded on the user's behalf without the user's prior knowledge, PVR screens showing a user's recorded shows typically indicate visually the recorded shows that are instances of preference recording.

The example show record of FIG. 6 includes data elements representing an identification code 241 for the show represented by the show record, a show title 241 a, a filename for the show 242, the genre of the show 243 (comedy, drama, sports, and so on), an owner identification field called ‘ownerID’ 244 recording the user ID of the user on behalf of whom the show is recorded, the estimated storage space requirement for the show 246, the duration of the show 247, a Boolean indication whether the show has been viewed by the owner 248, an indication of the source of the show 270, the schedule for recording the show 272, a record period for the show 274, and a retention period for the show 276.

Shows in the present example, however, are identified by identification codes 241, identification codes having no relationship to storage locations in storage space. There would be, for example, one identification code for a show titled 241a “Dukes of Hazzard,” another identification code for the show titled 241a “Star Trek,” and another for the show titled 241a “Buffy The Vampire Slayer.” Operating systems (154 on FIG. 4) generally organize storage space (166 on FIG. 4) in segments identified by filenames. Show records 240 according to FIG. 6 therefore provide a filename field 242 to record the location in storage space where a show is recorded so that shows can be located for viewing and later for deletion.

PVRs according to some embodiments of the present invention are programmed to utilize the ShowID field 241 as a completely unique key identifying a particular instance of a show to be recorded at a particular date and time, encoded in the Schedule field 272 in FIG. 6. Other embodiments are programmed to treat the ShowID 241 as a short identifier for a title such as “Star Trek” or “Buffy, The Vampire Slayer.” In embodiments that treat the ShowID 241 are a title identifier, PVRs can build a unique key for a particular instance of a show from the title 241a plus the date and time (Schedule 272) when the show is to be recorded.

The storage space requirement 246 and the duration 247 are related. The storage space requirement generally is expressed as some number of bytes, kilobytes, or megabytes of storage space. The duration 247 is generally expressed in minutes or hours, a half-hour show, a two-hour movie, and so on. Shows can be recorded in storage space using various kinds of compression ranging from no compression to lossless compression to quite lossy compression. For a show of a given duration, applying higher levels of compression reduces the storage space requirement for the show.

The source 270 can be encoded to indicate a channel number for capturing recorded content from broadcast television, cable television, or satellite television. The source 270 can be encoded with an Internet address identifying a source for downloading recordable content. Internet addresses can be encoded by use of dotted decimal addresses, Universal Resource Locators (“URLs”), or Universal Resource Identifiers (“URIs”).

The schedule 272 is a data element for storing the broadcast schedule of the show represented by the show record 240. For example, the schedule field 272 can be encoded with a date and time when a television show is broadcast and therefore to be recorded. The record period 274 provides an indication of a period over which a show may be recorded many times. For example, schedule 272 can be encoded with a schedule indication of Wednesday, 7:00 p.m., and record period 274 can be encoded with ‘January through June,’ resulting in recording the indicated show weekly for six months.

The retention period 276 is a field indicating how long to retain the show before deleting it. The retention period 276 and indications of viewing 248 can work together in various PVR according to embodiments of the present invention. In FIG. 6, for example, the PVR Profile 300 includes a Boolean indication whether to delete shows only after they are viewed, DeleteOnView 304. In a PVR according to FIG. 6, if DeleteOnView 304 is set True, then the PVR will not delete a show from storage space until the show is viewed, even if the view time is later than the end of the retention period 276. The PVR will retain the show until the end of the retention period if the end of the retention period is later than the time when the show is viewed. Alternatively, DeleteOnView 304 is reset False, and then the PVR deletes the show at the end of the retention period regardless whether the show has been viewed.

The Viewed field 248 in the show records 240 indicates whether the owner of the show has viewed the show. In a multi-user environment, however, it may be useful to retain the show in storage until more than one user has viewed it. The viewing records 250 in FIG. 6 are an alternative or an expansion of the use of the Boolean Viewed field 248 in the show records 240 to allow more than one user to express an interest in viewing the show and retain the show in storage space until all users indicating interest have viewed the show. The ShowID 252 is a foreign key linking the viewing records 250 to a show record 240. The ViewerID 254 is a user ID of a user indicating an interest in viewing the show identified by the ShowID 252. Viewed 256 is a Boolean indication whether the user identified as ViewerID 254 has viewed the show. The fact that a viewing record 250 exists bearing a particular ViewerID 254 can be treated as an expression of interest, or a Boolean field such as Interest 258 can be added to viewing records 250 as an affirmative expression of interest in viewing the show identified in ShowID 252.

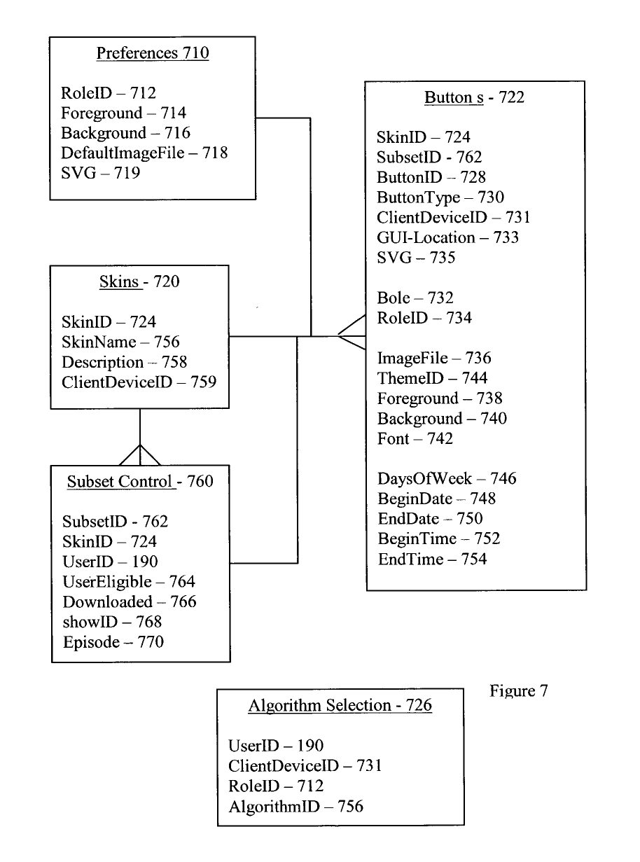

FIG. 7 sets forth a diagram depicting data structures useful with various embodiments of the present invention for representing and describing skins and buttons. The data structures of FIG. 7 include skin records 720, each of which represents a skin. The skin records 720 each provide a skin identification field, skinID 724, as well as optional additional descriptive fields for the skins, including in this example, a character field SkinName 756 for storing a name for a skin and a character field called ‘Description’ 758 for storing a text description for a skin.

The data structures of FIG. 7 include buttons records 722, each of which represents a button of a skin. The skin records 720 are related one-to-many to the buttons records 722 through the skinID field 724 used as a foreign key. Each button record 722 includes data elements for a button identification code, ‘buttonID’ 728; a type code, ‘buttonType’ 730; a code identifying a portion of a GUI with which a button is associated, GUI-Location 731; a role code, ‘role’ 732; a role identification code, ‘roleID’ 734; an image file name, ‘ImageFile’ 736; a theme identification code, ‘themeID’ 744; a foreground color, ‘foreground’ 738; a background color, ‘background’ 740; a font code, ‘font’ 742; identification of the days of the week when a button is potentially active, ‘daysOfWeek’ 746; a beginning date for an active period for a button, ‘beginDate’ 748; an ending date for an active period, ‘endDate’ 750; a beginning time for an active period, ‘beginTime’ 752; and an ending time for an active period, ‘endTime’ 754.

There are many data structures for buttons as will occur to those of skill in the art, all well within the scope of the present invention. The button records in 722 are merely exemplary. As such, several of the fields in the button records are optional. The fields for theme 744, foreground color 738, background color 740, and font 742 are optional, for example, depending on how graphics for the button are implemented. To the extent that graphics are in an image file, for example, theme, colors, and font were already established when the image file was created, with no particular name to register them in the button record.

More than one button can be associated with the same portion of a GUI for display and for interaction. Which of several associated buttons is to be created or instantiated for a particular download of a particular skin is determined by button creating algorithms. The role code 732 and the roleID 734 are used by button creating algorithms to select among two or more buttons available for the same portion of a GUI in a particular skin. Roles 732 are button selection codes that are given any value that can be used to select among buttons for a portion of a GUI.

Examples of roles include type codes for interested persons, such as, for example, ‘ISP,’ ‘manufacturer,’ ‘advertiser,’ and so on, so that a button creating algorithm can select a button that will display a logo or color scheme ordered by an advertiser, a manufacturer of a client device or intermediate appliance, a service provider, and so on. Roles include descriptive codes for content, such as, for example, ‘channel, ‘genre,’ ‘show,’ so that a button creating algorithm can select a button that will display a logo or color scheme associated with a television channel, a genre, or a particular show. Role typically include ‘user,’ so that a button creating algorithm can select buttons having themes, fonts, colors, or other attributes favored or preferred by a user of a client device or intermediate appliance.

The role identification code, roleID 734, identifies a particular instance of the role identified by the role code 732. If, for example, the role code is set to ‘user,’ then the roleID field 734 can contain a user's identification code, that is, a userID, so that a button creating algorithm can find the button records preferred by a particular user. If, for example, the role 732 is set to ‘channel,’ then the roleID 734 can contain a channel number, so that a button creating algorithm can find the button records previously uploaded by a particular television channel acting as an interested person. Similarly, if the role is ‘show,’ then the roleID can be a showID; if the role is ‘ISP,’ then the roleID can be set to an ISP's identification code, and so on for any role and role identification code as will occur to those of skill in the art, all of which are well within the scope of the present invention.

### Method and Devices for Creating Skins

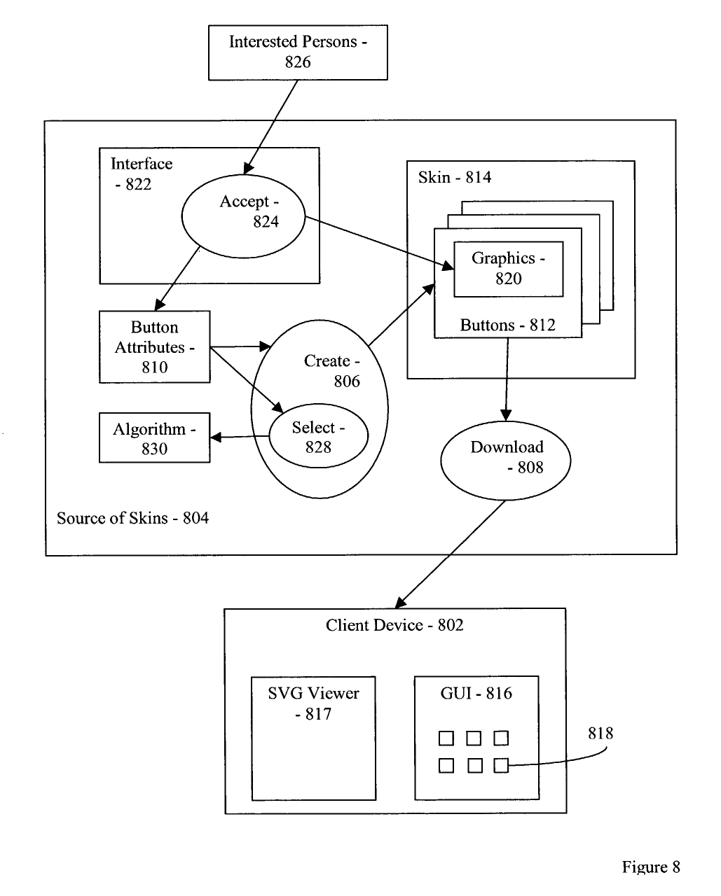

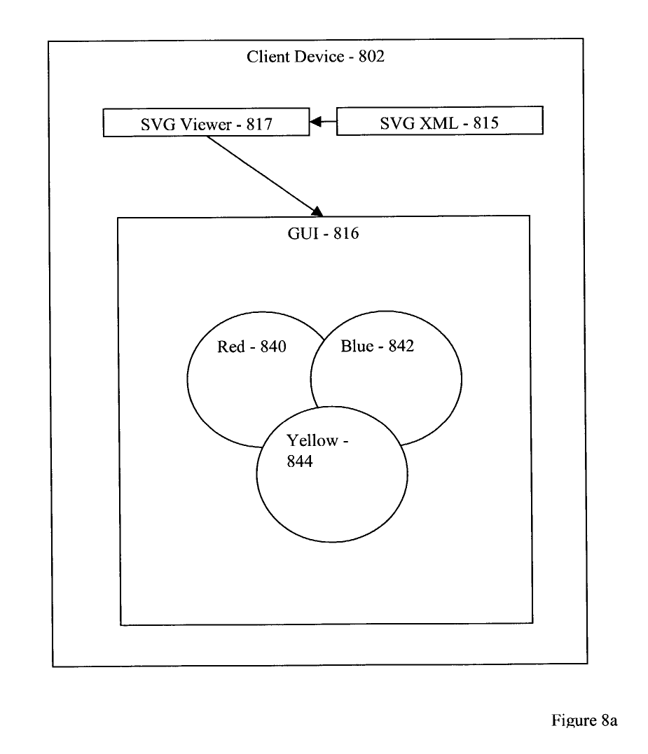

FIG. 8 sets forth a data flow diagram illustrating a method for creating a skin (814) for a client device (802). The method of FIG. 8 includes creating (806), in dependence upon button attributes (810), one or more buttons (812) for the skin (814). In the method according to FIG. 8, the skin comprises the one or more buttons for the skin, and each button includes graphics (812) associated with a portion (818) of a GUI (816) on a client device (802). The method of FIG. 8 includes downloading (808) the buttons (812) for the skin from a source of skins (804) to the client device (802).

Client devices, as defined above in this disclosure, are any aggregation of automated computing machinery supporting a GUI and capable of data communications with a source of skins. Client devices display button graphics in a portion of a GUI associated with the button. The portion of a GUI associated with a button can be interactive, that is, touch-sensitive or active with hardware controls such as keys or switches. Or the portion of the GUI for a button can be non-interactive, for display only, as for logos, backgrounds, or borders.

On at least some client devices according to the method of FIG. 8, at least a portion of the GUI on a client device is interactive, and the downloaded buttons affect interactive functions of the client device. An example of downloaded buttons affecting interactive functions of a client device is an embodiment that selects and creates buttons dependence upon userIDs providing disparate functions for parents with respect to children or disparate functions for administrative users with respect to ordinary users.

Because client devices include aggregation of automated computing machinery supporting a GUI and capable of data communications with a source of skins, client devices include devices, such as, for example, game machines and flight simulators, that are capable of displaying to users, in addition to graphics, many other perceptible events and stimuli including, for example, audio, video, tactile feedback, interactive motion, and force feedback events. Button according to the present invention include graphics associated with a portion of a GUI on the client device, but buttons also optionally include data structures representing or implementing other perceptible events and stimuli, including audio, video, tactile feedback, interactive motion, force feedback events, and others as will occur to those of skill in the art. Examples of such other perceptible events and stimuli include audio signals associated with a button press, a button release, a button click, and so on. Examples of such other perceptible events and stimuli include audible signals associated with mouseover, mouse down, and mouse click. Examples of such other perceptible events and stimuli include audible signals associated with keypresses and switch operations. Examples of such other perceptible events and stimuli include force feedback signals pointerovers, switch operations, and lever motions. Keypresses, switch operations, lever operations on game device, and the like, are physical operations detected in conjunction with display of graphics of a button according to the present invention.

In some embodiments according to the method of FIG. 8, the button graphics comprise scalable vector graphics. Scalable vector graphics, or “SVG,” is the subject of a Recommendation of the World Wide Web Consortium, the “W3C.” The Recommendation is dated Sep. 4, 2001, and is entitled, “Scalable Vector Graphics (SVG) 1.0 Specification.” The Recommendation is available from the W3C website at http://www.w3.org/TR/SVG.

SVG is an XML language for sophisticated two-dimensional graphics. SVG is specifically designed to work with other W3C standards such as Cascading Stylesheets (“CSS”), the Document Object Model (“DOM”), and the Synchronized Multimedia Integration Language (“SMIL”).

SVG graphics are scalable in the sense that they are capable of uniformly increasing or decreasing in size. That is, scalable means that SVG graphics are not limited to an image of single, fixed number of pixels. Contrast this with JPEG images. Each JPEG image comprises a particular size in pixels, such as, for example, 480 by 640. When a JPEG image is scaled up for display on a screen having more pixels than are in the JPEG, graphic detail from one pixel must be applied to more than one neighboring pixel, causing an increase in granularity of display that is often referred to as ‘pixelation.’ When a JPEG image is scaled down for display on a screen or portion of a screen having fewer pixels than are in the image, detail is lost. Both of these undesirable effects, pixilation and loss of detail upon scaling, are reduced or eliminated in SVG.

SVG graphics are scalable to different display resolutions, so that printed output, for example, uses a printer's full resolution and can be displayed at the same size on screens of different resolutions. The same SVG graphic can be placed at different sizes on the same Web page, and re-used at different sizes on different pages. SVG graphics can be magnified to show increased detail and as an aid to users with impaired vision.

SVG graphics are vectored in the sense that they comprise geometric objects such as lines and curves, giving greater flexibility of display compared to raster-only formats such as JPEG which have to store information for every pixel of an image. In addition, SVG images can integrate raster image and combine them with vector information to produce a complete illustration. Most, if not all, GUIs on client devices of the present invention are raster-oriented displays. Using SVG means that the rasterization occurs on the client-side rather than server-side, giving increased flexibility in many aspects of graphic displays on GUIs.

SVG provides data-driven graphics through XML. Implementing graphics as XML text, however, means that client devices using SVG need to include an SVG viewer (reference 817 on FIG. 8). Advantageously, an included SVG viewer is an SVG viewer in conformation with the W3C SVG Recommendation, a software program capable of parsing the XML for an SVG image and rendering its contents onto an output medium such as a GUI display or printer. SVG viewers can be implemented as plug-ins for browsers or microbrowsers. In Java environments, in addition to older Java graphics packages, such as the Java Swing package, there are Java implementation for SVG. Interested readers can learn more about Java SVG implementations from the Sun Microsystems website at:

http://wwws.sun.com/software/xml/developers/svg/java2d-api/.

Here is an example of a representation of an SVG image in XML:

<?xml version=“1.0”?>
<svg xmlns=“http://www.w3.org/2000/svg”>

<g style=“fill-opacity:0.7; stroke:black; stroke-width:0.1cm;”>

<circle cx=“6cm” cy=“2cm” r=“100” style=“fill:red;”

transform=“translate(0,50)”/>

<circle cx=“6cm” cy=“2cm” r=“100” style=“fill:blue;”

transform=“translate(70,150)”/>

<circle cx=“6cm” cy=“2cm” r=“100” style=“fill:yellow;”

transform=“translate(−70,150)”/>

</g>

</svg>

The example SVG XML implements an image with three overlapping circles colored respectively red, blue, and yellow. FIG. 8a depicts in black and white approximately what the SVG XML image 815 looks like when rendered through an SVG viewer 817 on a GUI 816 of a client device 802.

In some embodiments of the method according to FIG. 8, a method for creating skins according to the present invention includes accepting (824) in the source of skins (804) uploaded graphics (820) for buttons (812). In the example of FIG. 8, accepting 824 uploaded graphics includes accepting uploaded graphics through a button upload interface 822. In the example of FIG. 8, an interested person 826 uses the button upload interface 822 to provide button graphics to a source of skins 804.

In such embodiments, an interested person is any person or entity authorized by the source of skins to upload button graphics or other button attributes. Sources of skins in various embodiments authorize interested persons with a scope of authority in dependence upon elements of a business model, including, for example, whether the interested persons is a subscriber to downloads of skins and buttons or whether the interested person is an advertiser who has leased or otherwise paid ad fees for the right to have that interested person's logo displayed on particular portions of GUIs on client devices during some particular show, during broadcasts from a particular channel, through some particular range of dates and time, or in dependence upon some combination of all such factors and optionally others as well.

In the example, of FIG. 8, the repository 810 of uploaded graphics is labeled ‘button attributes.’ The repository 810 of uploaded graphics is labeled ‘button attributes’ to denote that there is no limitation regarding graphics as such. That is, interested persons optionally can upload, or edit on-line through an interface, other button attributes as well as graphics, including, for example attributes indicating dates and times when a button is to be activated, button colors, themes, fonts, and so on. Button attributes for upload or editing by interested persons include member methods in objects for implementing buttons, the member methods implementing actual display routines for displaying button graphics on GUIs on client devices. Similarly, to the extent that a button is interactive in its portion of a GUI, button attributes for upload or editing by interested persons include member methods in objects for implementing interactive functions or buttons, the member methods implementing actual interactive software routines for interactive functions responding to mouseovers, mouseclicks, button presses, and other interactive GUI button features as will occur to those of skill in the art, all of which are well within the scope of the present invention.

In some embodiments according to FIG. 8, creating (806) buttons includes selecting (828) a button creating algorithm (830). In methods for creating skins implemented in procedural software, algorithm selection can be carried out with a large switch statement or a series of if-then-else statements whose logic is driven with one or more independent variables. Computer programming languages often supporting procedural implementations include Basic, Cobol, C, and so on. Examples of independent variables include a userID of a user for whom a button is to be created and downloaded, current date and time read from a system clock, current showID read from a broadcast schedule, and so on. In such a procedural example, then, selecting a button creation algorithm can comprise selecting an algorithm that will create a button having a theme, colors, fonts, and so on, appropriate for a particular show.

Methods for creating skins often are implemented in object-oriented software, rather than procedural software. Computer programming languages often supporting object-oriented implementations include Smalltalk, C++, Java, and so on. In an object-oriented environment, where buttons are typically implemented as objects instantiated from button classes, a button class's constructor typically will comprise a button creating algorithm. In embodiments where a button class has only one constructor, then selecting a button creation algorithm comprises selecting a button and calling its constructor. To the extent that a button class's constructor is overloaded, selecting a button creations algorithm can comprise providing an appropriate set of parameters to call an appropriate constructor. Continuing with the exemplary independent variables mentioned above, a userID of a user for whom a button is to be created and downloaded, current date and time read from a system clock, and current showID read from a broadcast schedule, a button factory object can be implemented to select a button class through a switch statement in dependence upon such independent variables and call a constructor for the button class.

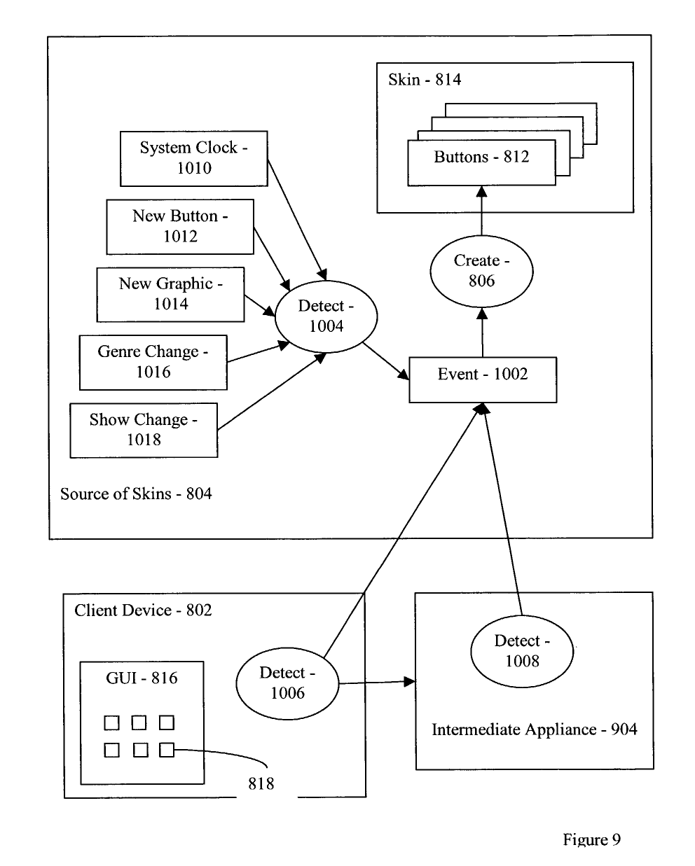

FIG. 9 sets forth a data flow diagram illustrating a further method for creating a skin (814) for a client device (802). The method of FIG. 9 includes detecting (1004) a button creation trigger event (1002). In the method of FIG. 9, creating (806) buttons further comprises creating buttons in response to the button creation trigger event (1002). In object oriented environments, buttons can be created by use of an abstract button class such as the following:

// abstract class for buttons, declaring a button interface
//
class Button
{

private String ImageFileName;
//
// interface function for displaying button graphic
// declare virtual function, define in subclasses
//
public int display(ImageFileName);
//
// declaration and definition of setImage( )
// available to all subclasses
//
public void setImage(String imageFileNameString)
{

ImageFileName = imageFileNameString;

}
//
// declaration and definition of getImage( )
// available to all subclasses
//
public String getImage( )
{

return imageFileNameString;
}
//
// ‘Set’ and ‘get’ functions for other button attributes are
// implemented as needed in concrete button subclasses.
//

}

The class ‘Button’ includes a member data element for a graphic image, the string named ‘ImageFileName,’ in which can be stored a file name for a graphics image file. The image file can be any kind of image file, SVG, JPEG, and so on.

The abstract class ‘Button’ includes a member method, ‘display( ),’ for displaying the button graphic. To the extent that the image file is an SVG file, then the display( ) function can pass the graphic to an SVG viewer in a client device. To the extent that the graphic is a JPEG file, a GIF file, or other bit-mapped image type, then the display( ) function can call library or package routines to output the image directly to a GUI on a client device.

The abstract class ‘Button’ includes set( ) and get( ) functions to insert and retrieve respectively an image file name to and from the class ‘Button.’ Rather than storing an image separately in a file, an array of bytes comprising a bit-mapped graphic can be stored directly as a member data element in a button class. Rather than storing an image separately in a file, an XML string comprising an SVG image can be stored directly as a member data element in a button class.

They are not shown in the pseudocode for the abstract button class, but readers will realize that concrete button classes will also often include member data elements, display( ) methods, set( ) methods, or get( ) methods for perceptible events and stimuli other than graphics. That is, concrete button classes will also often include member data elements, display( ) methods, set( ) methods, or get( ) methods for audio signals, video signals, data representing or implementing tactile feedback, data representing or implementing interactive motion, data representing or implementing force feedback events, and others as will occur to those of skill in the art.

Class ‘Button’ is an abstract class, a class to be used as a foundation on which to build many concrete button classes. In C++ environments, the subclasses inherit from the abstract class. In Java environments, a structure such as the class ‘Button’ is referred to as an ‘interface,’ and concrete subclasses are said to ‘extend’ the interface. The abstraction or ‘interface’ structure advantageously supports polymorphism, useful for many reasons, including, for example, instantiating button objects in a ‘factory’ design pattern, like the following exemplary button factory class.

//
// Button Factory Class
//
// Defines a parameterized factory method for creating button objects
//
class ButtonFactory
{

public static Button creatcButtonObject(algorithmID, selectionCriteria)
{

Button aButton = null; // establish pointer or reference for new object
switch(algorithmID)
{

case “algorithm1”:
// here insert processing logic comprising algorithm1,
// including, for example, selecting a button on the
// basis of selectionCriteria, and
// setting a graphics file name to the file name for
// an SVG file;
aButtonID = button.buttonID;
break;

case “algorithm2”:

// here insert processing logic comprising algorithm2,
// including, for example, selecting a button on the
// basis of selectionCriteria, and
// setting a graphics file name to the file name for
// a JPEG file;
aButtonID = button.buttonID;
break;

. . . . . . . . .
case “algorithmN-1”:

/* here insert processing logic comprising algorithmN-1 */; break;

case “algorithmN”:

/* here insert processing logic comprising algorithmN */; break;

} // end switch( )
switch(aButtonID)
{

case “button1”: aButton = new button1(SVG-FileName); break;
case “button2”: aButton = new button2(JPEG-FileName); break;
. . . . . . . . .

case “buttonN-1”: aButton = new buttonN-1; break;
case “buttonN”: aButton = new buttonN; break;

} // end switch( )
return aButton;

} // end createButtonObject( )

} // end class ButtonFactory

ButtonFactory implements a so-called parameterized factory design pattern, including a factory method. In this example, the factory method is a member method named ‘createButtonObject( ).’CreateButtonObject( ) accepts two parameters, an identification code for a button selection algorithm and selection criteria for operation of the algorithm. As a practical matter, the button selection algorithms typically will be programmed to obtain from their operating environment any needed values for their selection criteria, but the ‘selectionCriteria’ parameter is included in the pseudocode for ButtonFactory as a reminder for the need to do so.

CreateButtonObject( ) implements two switch statements. A first switch statement operates in dependence upon the algorithm identification code, and a second switch statement operates in dependence upon an identification code for a concrete button class identified by a button selection algorithm from the first switch statement. The second switch statement instantiates a button object of the concrete button class so identified. CreateButtonObject( ) then returns a reference to the newly created button object.

CreateButtonObject( ) returns the reference to the application software that called the factory method in the first place. The application software, in this example, is operating in response to a button creation trigger event to select a button creating algorithm.

The process of selecting a button creating algorithm can be carried out in dependence upon any selection criteria that can be represented with computer data. Consider the algorithm selection record structure illustrated at reference 726 on FIG. 7, for an example of how application software operating in response to a button creation trigger event can select a button creating algorithm. Consider an example in which a user having a userID identified in the data structure that communicates the occurrence of an event, and the userID is the only data available to comprise selection criteria for selection of a button creating algorithm. In such an example, application software operating in response to a button creation trigger event can select a button creating algorithm by finding in a table of algorithm selection records 726 the first record having the same userID 190. The application reads the algorithmID 756 from that record, calls the factory method createButtonObject( ), passes the algorithmID 756 as a parameter in the call to createButtonObject( ), receives a reference to a button object as a return value, and downloads the button object as the downloaded button.

Consider a further example in which a user operating a client device having a client device identification code operates the client device to change from one show to another on a PVR. In this example, changing shows is a button creation trigger event that communicates to the application the client device identification code and a show identification code for the new show. The client device identification code and the show identification code for the new show comprise selection criteria for selection of a button creating algorithm. In such an example, the application software operating in response to the button creation trigger event can select a button creating algorithm by finding in a table of algorithm selection records (726 on FIG. 7) the first record having a clientDeviceID 731 equal to the client device identification code and a roleID 712 equal to the show identification code. The application then reads the algorithmID 756 from that record, calls the factory method createButtonObject( ), passes the algorithmID 756 as a parameter in the call to createButtonObject( ), receives a reference to a button object as a return value, and downloads the button object as a downloaded button.

This discussion just set forth two examples of selecting button creating algorithms. As mentioned above, the process of selecting a button creating algorithm can be carried out in dependence upon any selection criteria that can be represented with computer data. In addition, there are many ways of carrying out that selection, record searches as just discussed above, switch statements, expert systems, and so on, as will occur to those of skill in the art, and all such ways are well within the scope of the present invention.

Further with respect to FIG. 9: In some embodiments of the present invention, detecting button creation trigger events is carried out in a distributed fashion. In such embodiments, some sources of skins have a detector function (1004) that triggers creation of buttons for skins and then pushes downloads to PVRs. In such embodiments, some PVRs (904) have a detector function (1008) that transmits a detected event (1002) event uplink to a source of skins (804) which then creates (806) buttons (806), puts them in a skin (814) or treats them individually, and downloads them, effectively implementing a ‘pulled’ download.

In such embodiments, some client devices include a detector function (1006) that uplinks a detected event (1002). The uplink can be direct (1006, 1002) or through an intermediate appliance (1006, 904, 1002). Examples of events advantageously detected by a client device include a user's changing shows or channels, hence affecting genre, showID, and optionally other button attributes also. Another example of an event advantageously detected by a client device rather than an intermediate appliance or source of skins is the fact that the user as such changes. That is, one user puts down a remote control device, and another user picks up the remote and logs in with a PIN.

### Triggers for Date and Time

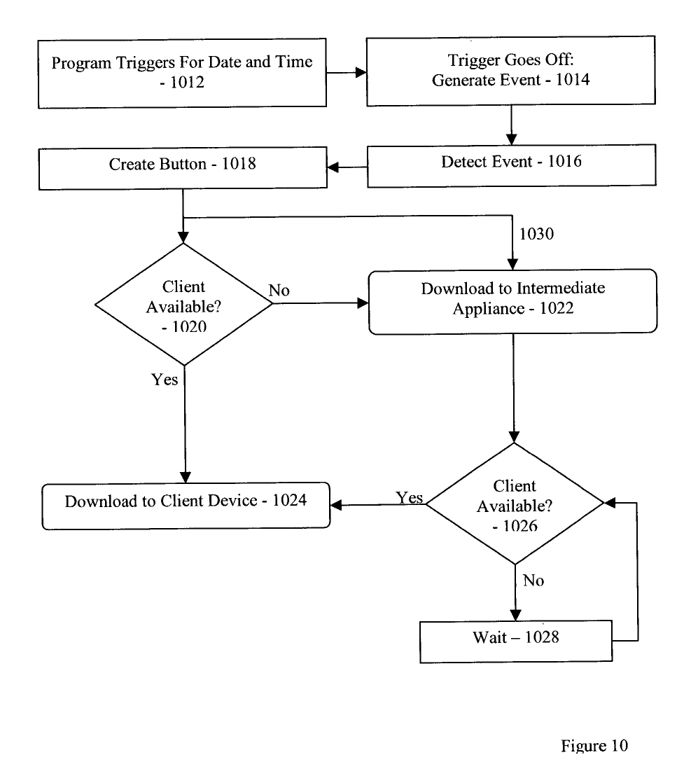

FIG. 10 sets forth a flow chart depicting a further method of creating and downloading a skin for a client device. The method of FIG. 10 includes programming triggers 1012 for date and time. The triggers are software triggers that go off regardless whether the client device is presently available to receive downloaded buttons. A trigger's going off comprises generation of an event 1014. Events of concern among embodiments of the present invention usually include button creation trigger events. The method of FIG. 10 includes detecting 1016 such button creation trigger events, creating buttons 1018 in dependence upon them, and checking at the source of skins level for client device availability 1020.

A source of skins can check whether a client device is presently available to receive a download, by, in effect, ‘pinging’ the client device, that is, by sending to the client device any test message a response to which from the client device represents that the client device in presently coupled for data communications to the source of skins and available to receive downloads. A client device can be unavailable to receive downloads for a variety of reasons. A client device can be unavailable because it is powered off. A client device coupled wirelessly for RF data communications can be out of RF range of a source of skins, an intermediate appliance, or an RF coupling. A client device coupled wirelessly for IR data communications can be pointed away from or out of line of sight from a source of skins, an intermediate appliance, or an IR coupling. In the case of a client device that is a IR remote control for a television, in this example, triggers for date and time go off even if the remote control is not positioned to receive IR broadcast from the TV.

If a client device is available to receive a download, then the method of FIG. 10 downloads 1024 the created buttons to the client device. If a client device is not available to receive a download, then the method of FIG. 10 downloads 1022 the created buttons to an intermediate applicance with which the client device is associated, such as, a PVR, DVD, CD, cable television set top box, a radio receiver, a satellite television receiver, and so on. That is, the client device can be a remote control associated with any such intermediate appliance.

The method of FIG. 10 includes an alternative exemplary path of execution 1030 in which the created buttons are downloaded 1022 to an intermediate appliance without first checking to see whether a client device is available 1020. This alternative exemplary method is useful when, for example, a source of skins possesses no means of direct communications with a particular client device, but can still make the download to an intermediate appliance.

The method of FIG. 10 includes checking 1026 at the level of the intermediate appliance whether a client device is available for a download. An intermediate appliance can check for client device availability in similar ways as a source of skins checks, for example, by pinging the client device with any suitable test message. A client device can be unavailable to receive downloads from an intermediate appliance for similar reasons as with sources of skins, including power off, out of RF range, and out of position for IR communications. If a client device is not available to receive a download from an intermediate appliance, the method of FIG. 10 includes waiting 1028 until a client device becomes available for download and then proceeding with a download to the client device 1024.

Events generated by triggers for date and time include purely time related events. For example, a user's preferences can include changing the user's skins among preselected skins hourly, regardless of other attributes. Events generated by triggers for date and time also include events that are not purely time related. That is, events generated by triggers for date and time include more than purely time related events. For example, a trigger for date and time can be programmed, in generating an event, to identify show changes and associated genre changes on the hour or half-hour. In this example, show changes and genre changes are attributes of a show, not purely time related. Or a trigger for date and time can be programmed in generating an event to identify the beginning time for a commercial as an event in dependence upon which a button set with be created as ordered by the same advertiser who ordered the commercial. In this example, the commercial attribute is considered an attribute not related exclusively to time and date.

### Incremental Downloads

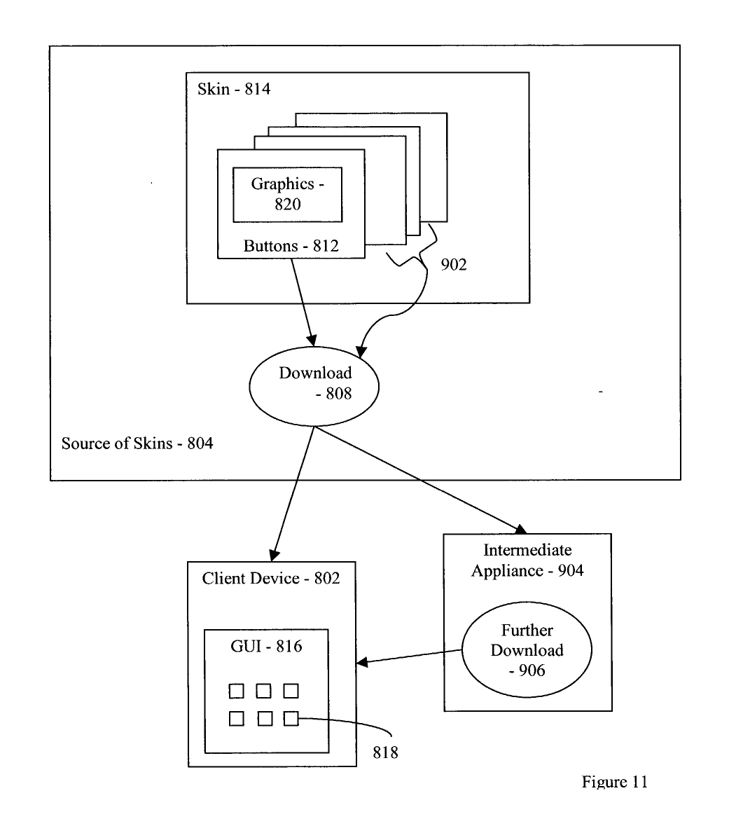

FIG. 11 sets forth a data flow diagram illustrating a further method for creating a skin 814 for a client device 802. In the method of FIG. 11, downloading 808 the buttons 812 for a skin 814 includes downloading 808 the buttons 812 from a source of skins 804 to an intermediate appliance 904 and further downloading 906 the buttons from the intermediate appliance 904 to the client device 802. Examples of intermediate appliances useful with various embodiments of the present invention include personal computers, PVRs, and OSGi compliant gateways coupling to client devices through HAVi.

It is common in embodiments of the present invention, that downloading buttons from a source of skins to a client device includes downloading all the buttons for the skin, that is, in effect, downloading the entire skin. Downloading the entire skin, however, is not a limitation of the invention. In an alternative according to FIG. 11, downloading 808 buttons 812 for a skin from a source of skins 804 to a client device 802 includes downloading only a subset 902 of the buttons for the skin.

Downloading only a subset of the buttons for a skin, by comparison with downloading the entire skin, makes more efficient use of bandwidth available for downloads. In addition, the availability of such partial downloads means that for the first time, skin administration can operate with more detail than can be had by downloads of entire skins. For example, subsets of buttons can be downloaded in dependence upon user privilege level, so that users with ordinary usage privileges do not receive the same button subset as do super users or users having administrative privileges. Moreover, the availability of partial downloads can support various new business models, such as, for example, one in which a skin is downloaded in three subsets of buttons, one subset for each of three episodes of a miniseries, so that, as an enticement to view the entire miniseries, a user only obtains the full button set for the skin after viewing all three episodes.

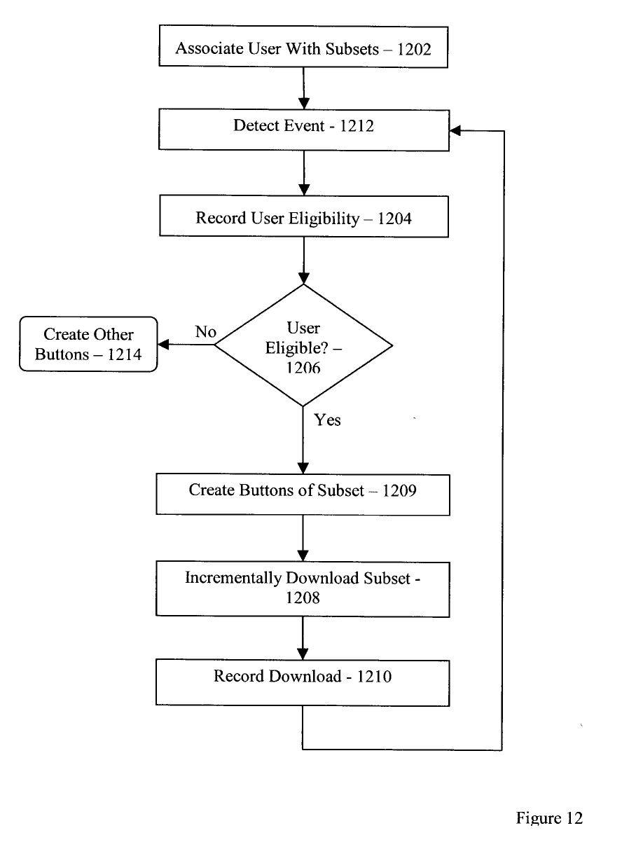

FIG. 12 sets forth a flow chart depicting a method of creating and downloading skins comprising multipart, incremental downloads of skins. The method of FIG. 12 is explained with reference also to the data structures of FIG. 7, including particularly the subset control records 760. In the method according to FIG. 12, downloading the buttons for a skin further comprises incrementally downloading 1208 two or more staggered subsets of the buttons for a skin to entice viewers to take one or more predetermined actions. An example of incrementally downloading 1208 two or more staggered subsets of the buttons for a skin to entice viewers to take one or more predetermined actions is incrementally downloading 1208 two or more staggered subsets of the buttons for a skin to entice viewers to watch all episodes of a multipart show. That is, during a three-episode miniseries, the skin can be partially downloaded during each of the three episodes. Download of the skin associated with the show is completed in this example only upon viewing of the final episode.

Incrementally downloading 1208 two or more staggered subsets of the buttons for a skin to entice viewers to take one or more predetermined actions is not limited to watching all the episodes of a multipart show. This feature can also apply to watching a certain number of commercials, or other types of programs. In other words, in this kind of embodiments, there are two or more components, button, or subsets of buttons for a skin, and to earn all those components, buttons, or subsets, a user must do some number of predetermined activities. The number of subsets of buttons and the number of predetermined activities to earn all the subsets, that is, the entire skin, are not required to be equal. In one case, for example, there are three subsets and six predetermined actions, with one subset downloaded after a user completes every other action.

The method of FIG. 12 includes associating 1202 a user with a subset of the buttons for a skin. Associating a user with a subset of buttons for a skin, in this example, is carried out by creating a subset control record of the kind illustrated at reference 760 in FIG. 7. Each subset control record represents a subset of buttons for a skin that a user can become eligible to download. The user who can so become eligible is identified in a ‘userID’ field 190. Whether the user is presently eligible for download of a particular subset of buttons for a skin is indicated in a Boolean field named ‘UserEligible’ 764. Whether the download has been carried out for a particular subset of buttons for a skin is indicated by Boolean field named ‘Downloaded’ 766. Button records 722 representing the buttons in a subset are related to the subset control records 760 many-to-one through a ‘subsetID’ field 762 used as a foreign key. The subset control records 760 are shown related many-to-one to skin records 720 through a ‘skinID’ field 724 used as a foreign key.

Detect button creation trigger events 1212 before recording user eligibility 1204 because some button creation trigger events affect user eligibility, including, for example, a button creation trigger event representing a user's logging on and tuning in a particular show, an event which can trigger the user's eligility for an incremental download of a subset of buttons for a skin.

The method of FIG. 12 includes recording user eligibility 1204. Recording user eligibility can be carried out by recording, when a subset control record is first created, the default value ‘false’ in a Boolean indicator, such as, for example, the field ‘UserEligible’ 764, so that the user is initially not eligible for download of any subsets of buttons. Alternatively, a user's registering to qualify for incremental downloads can itself be programmed to provide eligibility for a first subset of buttons for a skin, so that one subset control record is initially marked ‘true’ for UserEligible 764, while other subset control records having the same skinID and the same userID are initially marked ‘false’ for UserEligible 764.

In addition to initial settings, recording user eligibility is also carried out in dependence upon button creation trigger events. The method of FIG. 12 also includes detecting button creation trigger events 1212. Button creation trigger events comprise events affecting user eligibility for downloads of subsets of buttons for skins, including, for example, the fact that a user has logged on to a client device with a PIN and then tuned an intermediate appliance such as a television, set top box, or PVR to display or download a particular episode of a miniseries. In this example, the illustrated exemplary method, explained in terms of the data structures of FIG. 7, includes finding a subset control record with data elements matching the userID 190, the showID 768, and the episode number 770. Recording user eligibility 1204 then includes setting UserEligible 764 to true on the subset control record so found.

The method of FIG. 12 includes determining user eligibility 1206 for an incremental download of a subset of buttons for a skin. In this example, in terms of the example data structures of FIG. 7, determining user eligibility comprises reading the value of a UserEligible field 764 in a subset control record 760 for the subset in question, ‘true’ or ‘false.’ If the user is eligible, then the method includes creating buttons of the subset 1209, incrementally downloading the buttons for the subset 1208, and recording the download in the pertinent subset control record 1210.

The fact that a user is not eligible for an incremental download of a subset does not mean, however, that no buttons are created in response to a button creation trigger event. The fact that a user is not eligible for an incremental download of a subset does mean that buttons other than the subset buttons are created in response to a button creation trigger event 1214. That is, creating buttons in dependence upon button attributes and downloading the buttons so created as described in detail above in this disclosure, although, in this example, the buttons so created typically will be buttons other than the buttons for the subset in question.

The method of FIG. 12 includes, when a use is determined eligible 1206, creating buttons for a subset of a skin 1209. In this example, in terms of the data structures of FIG. 7, when the subset control records are sorted or indexed on a sort rule or index that includes subsetID 762, creating the buttons for a subset comprises finding the first subset control record 760 for a skin identified by skinID 724 for which UserEligible 764 is ‘true’ and ‘Downloaded’ 766 is ‘false.’Creating the buttons for a subset then comprises creating the buttons represented by button records 722 having the same subsetID 762 value as the subset control record 760 so found.

The method of FIG. 1208 includes incrementally downloading the buttons of a subset of a skin. Incrementally downloading comprises downloading only one subset at a time. In many embodiments, incrementally downloading comprises downloading two or more staggered subsets of the buttons for a skin. It is a particular element of incremental downloading in many embodiments of the illustrated method to download staggered subsets of buttons for a skin to entice viewers to watch all episodes of a multipart show.

The method of FIG. 12 includes recording the fact that a download of a particular subset has occurred 1210. Recording downloads is particularly useful in embodiments that track user eligibility in data structure similar to those of FIG. 7, so that button creation processes can know whether a particular subset has or has not already been downloaded. Recording downloads in such embodiments is useful because button creation trigger events can be ambiguous.

An example of such an ambiguous button creation trigger event is a user logging on with a PIN and tuning in to watch a second episode of a miniseries that the user has already watched once before. When the user previously watched the episode, a corresponding subset of buttons for a skin for the episode was created and downloaded, and an embodiment of the illustrated method recorded 1210 that fact, by, for example, writing the value ‘true’ to a Boolean download tracking field such as ‘Downloaded’ 766 in a pertinent subset control record 760. Upon receiving the button creation trigger event representing the user's logon to watch the second episode for a second time, the button creation step 1209 can advantageously detect that fact by reading the value of ‘Downloaded’ 766 from the pertinent subset control record and thereby avoid a second download of a subset that has already been created and incrementally downloaded.

Button creation trigger events useful in a method according to FIG. 12 include events generated by triggers for date and time, as described in more detail above in this specification, thereby making available ‘pushed’ incremental downloads, that is, incremental downloads triggered by events not necessarily related to user operations of client devices or intermediate appliances. More particularly, IR or RF based remote controls can have a capability to receive ‘pushed’ content from content-controlling and displaying intermediate appliances such as PVRs, DVDs, CDs, set top boxes for cable television, set top boxes for satellite television, radio receivers, and others as will occur to those of skill in the art.

As users become fan's of particular show content, they often become willing to pay for memorabilia connected to that content. Downloadable attributes of buttons therefore can include rings for cell phone comprising passages from popular songs. Similarly downloaded buttons for skins for client devices for entertainment broadcasting, televisions and radios, can include as button attributes popular audio and video segments.

Skins and buttons for skins can be downloaded for free, replacing the look and feel, such as button graphics and sounds, of a remote, thereby functioning as advertising for the show content and to increase fan loyalty. Alternatively, skins and buttons for skins can be downloaded for a charge for a custom skin to be delivered to a client device such as a remote control device for a television or PVR, a PDA, or a mobile phone.

Because buttons for skins according to embodiments of the present invention can be created in dependence upon events generated from triggers for date and time as well as events generated from actions on a client device or intermediate appliance, skins can be rotated based on time sharing, time and day, or user of a remote. For example, in a household where more than one user uses a particular remote control for a PVR, each user may have their own presentation/skin/content downloaded to the remote for the period of their possession of that remote. Identifying the user can not only change the layout and presentation of the remote, it can also allow for changes in behavior in the remote, that is, user A can have more options or privileges than user B. In typical embodiments, identification of a particular user is achieved by a user login identification code such as a PIN or by having a tool bar displayed containing all of the household users available for selection.

In embodiments that utilize an intermediate appliance such as a PVR, skins and their buttons often can be advantageously stored in the intermediate appliance itself so as to speed the process of downloading and rotation into a client device such as a remote control. Applications software on an intermediate appliance such as a PVR can be programmed with steps of methods of the present invention so that such an intermediate appliance can receive and accept downloads of buttons and skins, further downloading them to client devices on demand or on a scheduled basis, so that buttons and skins are in effect pulled down from sources of skins and stored intermediately on such an appliance.

Where buttons for skins are stored intermediately in such an intermediate appliance, they may automatically or manually be pushed to the remote during the viewing of shows or commercials. It is often the case that wireless couplings, such as IR or RF couplings, between intermediate appliances and client devices have relatively narrow bandwidths. Intermediate storage of buttons and skins, where buttons are further downloaded to client devices on demand, has the additional advantage of conserving the bandwidth between intermediate appliances and client devices.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for creating a skin for a client device, the method comprising the steps of:
creating, in dependence upon button attributes, one or more buttons for the skin, wherein the skin comprises the one or more buttons for the skin and each button comprises graphics associated with a portion of a GUI on the client device; and
downloading the one or more buttons for the skin from a source of skins to the client device.

2. The method of claim 1 wherein downloading the buttons for a skin from a source of skins to the client device further comprises downloading only a subset of the buttons for the skin.

3. The method of claim 2 wherein downloading the buttons for a skin further comprises incrementally downloading two or more staggered subsets of the buttons for a skin to entice viewers to take one or more predetermined actions.

4. The method of claim 1 further comprising detecting a button creation trigger event, wherein creating buttons further comprises creating buttons in response to the button creation trigger event.

5. The method of claim 4 further comprising programming triggers for date and time, wherein the triggers go off regardless whether the client device is presently available to receive downloaded buttons.

6. The method of claim 1 wherein downloading the buttons for a skin further comprises:
downloading the buttons from a source of skins to an intermediate appliance; and
further downloading the buttons from the intermediate appliance to the client device.

7. The method of claim 1 wherein at least a portion of the GUI on the client device is interactive, and the downloaded buttons affect interactive functions of the client device.

8. A system for creating a skin for a client device, the system comprising:
means for creating, in dependence upon button attributes, one or more buttons for the skin, wherein the skin comprises the one or more buttons for the skin and each button comprises graphics associated with a portion of a GUI on the client device; and
means for downloading the one or more buttons for the skin from a source of skins to the client device.

9. The system of claim 8 wherein means for downloading the buttons for a skin from a source of skins to the client device further comprises means for downloading only a subset of the buttons for the skin.

10. The system of claim 9 wherein means for downloading the buttons for a skin further comprises incrementally downloading two or more staggered subsets of the buttons for a skin to entice viewers to take one or more predetermined actions.

11. The system of claim 8 further comprising means for detecting a button creation trigger event, wherein means for creating buttons further comprises means for creating buttons in response to the button creation trigger event.

12. The system of claim 11 further comprising means for programming triggers for date and time, wherein the triggers go off regardless whether the client device is presently available to receive downloaded buttons.

13. The system of claim 8 wherein means for downloading the buttons for a skin further comprises:
means for downloading the buttons from a source of skins to an intermediate appliance; and
means for further downloading the buttons from the intermediate appliance to the client device.

14. A computer program product for creating a skin for a client device, the computer program product comprising:
a recording medium;
means, recorded on the recording medium, for creating, in dependence upon button attributes, one or more buttons for the skin, wherein the skin comprises the one or more buttons for the skin and each button comprises graphics associated with a portion of a GUI on the client device; and
means, recorded on the recording medium, for downloading the one or more buttons for the skin from a source of skins to the client device.

15. The computer program product of claim 14 wherein means, recorded on the recording medium, for downloading the buttons for a skin from a source of skins to the client device further comprises means, recorded on the recording medium, for downloading only a subset of the buttons for the skin.

16. The computer program product of claim 15 wherein means, recorded on the recording medium, for downloading the buttons for a skin further comprises incrementally downloading two or more staggered subsets of the buttons for a skin to entice viewers to take one or more predetermined actions.

17. The computer program product of claim 14 further comprising means, recorded on the recording medium, for detecting a button creation trigger event, wherein means, recorded on the recording medium, for creating buttons further comprises means, recorded on the recording medium, for creating buttons in response to the button creation trigger event.

18. The computer program product of claim 17 further comprising means, recorded on the recording medium, for programming triggers for date and time, wherein the triggers go off regardless whether the client device is presently available to receive downloaded buttons.

19. The computer program product of claim 14 wherein means, recorded on the recording medium, for downloading the buttons for a skin further comprises:
means, recorded on the recording medium, for downloading the buttons from a source of skins to an intermediate appliance; and
means, recorded on the recording medium, for further downloading the buttons from the intermediate appliance to the client device.
